(19) United States
(12) Patent Application Publication
(10) Pub. No.: US 2017/0146732 A1
(43) Pub. Date: May 25, 2017

(54) METHOD OF APPLYING ADHESION PROMOTER TO OPTICAL FIBER

(71) Applicant: Corning Incorporated, Corning, NY (US)

(72) Inventors: John William Botelho, Corning, NY (US); Ching-Kee Chien, Horseheads, NY (US)

(21) Appl. No.: 15/337,459

(22) Filed: Oct. 28, 2016

Related U.S. Application Data
(60) Provisional application No. 62/258,031, filed on Nov. 20, 2015.

(51) Int. Cl. G02B 6/02; B05D 1/02; B05D 3/00

(52) U.S. Cl. CPC G02B 6/02395; B05D 3/007; B05D 1/02

(57) ABSTRACT

Methods of applying adhesion promoters to optical fibers are described. The methods include direct application of an adhesion promoter onto the surface of the optical fiber. The adhesion promoter is applied in liquid form as a neat compound or as a component of a liquid solution to the surface of the optical fiber. The adhesion promoter bonds to the optical fiber and includes functional groups that permit bonding with an overlying polymer coating to improve the adhesive strength of the polymer coating to the fiber.

This application claims the benefit of priority under 35 U.S.C. §119 of U.S. Provisional Application Ser. No. 62/258,031 filed on Nov. 20, 2015 the content of which is relied upon and incorporated herein by reference in its entirety.

### FIELD

This specification pertains to optical fibers with coatings. More particularly, this specification pertains to methods of applying adhesion promoters to optical fibers to improve the adhesive strength of coatings to optical fibers.

### BACKGROUND

The light transmitting performance of an optical fiber is highly dependent upon the properties of the polymer coating that is applied to the fiber during manufacturing. Typically a dual-layer coating system is used where a soft (low modulus) primary coating is in contact with the glass fiber and a hard (high modulus) secondary coating surrounds the primary coating. The secondary coating allows the fiber to be handled and further processed, while the primary coating plays a key role in dissipating external forces and preventing them from being transferred to the fiber where they can cause microbend induced light attenuation.

The functional requirements of the primary coating place several constraints on the materials that are used for these coatings. In order to prevent bending and other external mechanical disturbances from inducing losses in the intensity of the optical signal transmitted through the fiber, the Young's modulus of the primary coating must be as low as possible (generally less than 1 MPa, and ideally less than 0.5 MPa). To ensure that the modulus remains low when the fiber is exposed to low temperatures during deployment in cold climates, the glass transition temperature of the primary coating must be low (generally less than 0° C., and ideally less than −20° C.) so that the primary coating does not transform to a rigid glassy state. Also, the tensile strength of the primary coating, must be high enough to prevent tearing defects when drawing the fiber or during post-draw processing of the coated fiber (e.g. when applying ink layers or bundling the fiber to form cables). Obtaining the necessary tensile strength is challenging because tensile strength generally decreases as the modulus decreases. This means that the objectives of achieving low modulus conflicts with the objective of achieving high tear strength. Lastly, to ensure uniformity in the thickness of the primary coating, the composition from which the primary coating is formed is applied to the fiber in liquid form. A liquid primary coating composition flows to provide uniform coverage of the fiber to promote uniformity of thickness in the cured state. It is similarly beneficial to employ a liquid phase secondary coating composition. It is desirable, however, to apply a liquid secondary coating composition to the cured state of the primary coating to prevent mixing of liquid phases and potential contamination of the primary coating with components of the secondary coating (and vice versa). To achieve this goal while maintaining high draw speeds, the liquid phase primary coating composition must be capable of curing quickly to form a solidified primary coating having sufficient integrity to support application of a liquid secondary coating composition.

To meet these requirements, optical fiber coatings have traditionally been formulated as mixtures of radiation-curable urethane/acrylate oligomers and radiation-curable acrylate functional diluents. Upon exposure to light and in the presence of a photoinitiator, the acrylate groups rapidly polymerize to form a crosslinked polymer network which may be further strengthened by the hydrogen bonding interactions between urethane groups along the oligomer backbone. By varying the chemical structure and relative proportions of urethane/acrylate oligomer and functional diluents in the coating composition, it is possible to form primary coatings having very low modulus values while still providing sufficient tensile strength to minimize damage during the draw or post-draw processing as well as secondary coatings having sufficiently high modulus values to provide mechanical integrity to the fiber. Numerous optical fiber coating formulations have been disclosed in which the composition of the radiation-curable urethane/acrylate oligomer and functional diluents has been varied to achieve different property targets.

To realize the functional and protective benefits of the coatings, it is necessary to achieve strong adhesion of the primary coating with both the secondary coating and the optical fiber. Adhesion of the secondary coating to the primary coating is generally not problematic because of the chemical similarity and compatibility of the primary and secondary coatings. Adhesion of the primary coating to the optical fiber, however, is more difficult to achieve because the optical fiber is typically an inorganic glass while preferred primary coatings are organic polymers. The optical fiber includes a central core surrounded by a cladding and the primary coating is applied to the cladding. The core is typically an updoped silica glass (e.g. Ge-doped silica) and the cladding typically includes one or more undoped or downdoped silica glass layers (e.g. updoped silca, F-doped silica).

Adhesion of the primary coating to the cladding is of critical importance. If the primary coating delaminates from the cladding, moisture can enter into the optical fiber and degrade the silica glass. Incorporation of moisture in the optical fiber increases attenuation losses of optical signals in the fiber by providing OH groups that absorb signal intensity at wavelengths critical to telecommunication applications. Degradation of the fiber occurs when the delaminated coating slides against the surface of the cladding and causes microscopic scratches at the surface. The microscopic scratches act as crack initiation points that weaken the overall strength of the fiber.

To counter delamination and promote the adhesion of the disparate materials of the cladding and primary coating layer, an adhesion promoter is included in the primary coating composition. An adhesion promoter is a chemical agent that becomes incorporated in the primary coating and further bonds to the surface of the optical fiber. Adhesion is improved because the adhesion promoter forms chemical bonds with both the optical fiber and primary coating formed by curing the primary coating composition.

The presence of an adhesion promoter in the primary coating composition, however, can lead to undesirable side effects. First, adhesion promoters can react with other constituents in the primary coating composition and reduce the cure rate of the primary coating. Since the coating of the optical fiber is preferably performed in a continuous fiber draw process, reductions in the cure rate of the primary coating increase process time and diminish process efficiency. Second, since adhesion of the primary coating occurs only at the interface of the primary coating with the surface of the optical fiber, presence of the adhesion promoter throughout the primary coating is unnecessary from the perspective of both performance and cost. Third, inclusion of adhesion promoters in the primary coating composition limits the shelf life of the primary coating composition. Most preferred adhesion promoters are sensitive to moisture and lose functionality over time due to hydrolysis reactions.

There is a need to develop methods for forming primary coatings on glass optical fibers that promotes strong adhesion without sacrificing the efficacy or stability of the primary coating composition.

### SUMMARY

Methods of applying adhesion promoters to optical fibers are described. The methods include direct application of an adhesion promoter to the surface of the optical fiber. The adhesion promoter is applied in liquid form. The adhesion promoter may be a liquid compound and applied in the neat state to the surface of the optical fiber. The adhesion promoter may be a component of a liquid solution and the liquid solution may be applied to the surface of the optical fiber. The liquid solution may also include a solvent. The adhesion promoter physically or chemically interacts with the surface of the optical fiber and includes groups that permit physical or chemical interactions with an overlying polymer coating to improve the adhesive strength of the polymer coating to the fiber. Chemical interactions include formation of chemical bonds. The adhesion promoter may form an adhesion primer layer on the surface of the optical fiber. The method may further include forming a primary coating on the adhesion primer layer. The method may also include forming a secondary coating on the primary coating.

The present specification extends to:

A method of processing an optical fiber comprising:

applying a non-curable liquid to the surface of an optical fiber, said non-curable liquid comprising an adhesion promoter.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 is a schematic view of a coated optical fiber according one embodiment.

FIG. 2A and FIG. 2B depict reactions of adhesion promoters with surface hydroxyl groups of an optical fiber.

FIG. 3 depicts an embodiment of a system for applying an adhesion promoter to an optical fiber in a continuous manufacturing process.

FIG. 4 depicts an embodiment of a system for applying an adhesion promoter to an optical fiber in a continuous manufacturing process.

FIG. 5 depicts an embodiment of a system for applying an adhesion promoter to an optical fiber in a continuous manufacturing process.

FIG. 6 depicts an adhesion promoter application stage.

FIG. 7 depicts a device for improving uniformity of an adhesion promoter applied in liquid form.

FIG. 8 shows the dependence of peel strength of a thin film formed from a liquid solution containing an adhesion primer as a function of the concentration of adhesion promoter in the liquid.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and/or C are disclosed as well as a class of substituents D, E, and/or F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

As used herein, the term “curable” is intended to mean that the component, when exposed to a suitable source of curing energy, includes one or more curable functional groups capable of forming covalent bonds that participate in linking the component to itself or to other components to form a polymeric coating material (i.e., the cured product). The curing process may be induced by energy. Forms of energy include radiation or thermal energy. A radiation-curable component is a component that can be induced to undergo a curing reaction when exposed to radiation of a suitable wavelength at a suitable intensity for a sufficient period of time. The radiation curing reaction may occur in the presence of a photoinitiator. A radiation-curable component may also optionally be thermally curable. Similarly, a thermally-curable component is a component that can be induced to undergo a curing reaction when exposed to thermal energy of sufficient intensity for a sufficient period of time. A thermally curable component may also optionally be radiation curable.

A curable component may include one or more curable functional groups. A curable component with only one curable functional group may be referred to herein as a monofunctional curable component. A curable component having two or more curable functional groups may be referred to herein as a multifunctional curable component or a polyfunctional curable component. Multifunctional curable components include two or more functional groups capable of forming covalent bonds during the curing process and may introduce crosslinks into the polymeric network formed during the curing process. Multifunctional curable components may also be referred to herein as “crosslinkers” or “curable crosslinkers”. Examples of functional groups that participate in covalent bond formation during the curing process are identified hereinafter.

As used herein, the terms “non-curable” and “non-radiation curable” refer to a compound or component of a coating composition that lacks functional groups capable of forming covalent bonds when exposed to the source of curing energy (radiation, thermal) during the curing process. The term “non-reactive” refers to a compound or component of a coating composition that does not react with other components of the coating composition under the conditions used in curing the coating composition. Non-reactive compounds or components are also non-curable.

Reference will now be made in detail to illustrative embodiments of the present description.

The present specification provides methods for making optical fibers with coatings. The methods include forming a primary coating on an optical fiber by applying a liquid to the surface of the optical fiber and forming an adhesion-primer layer on the surface of the fiber. The liquid includes an adhesion promoter and optionally includes a solvent. The liquid may be non-curable or non-radiation curable. The liquid may lack a curable component. The liquid may lad a radiation-curable component. The adhesion promoter may be non-curable. The adhesion promoter may be non-radiation curable. The adhesion promoter may be a liquid and applied in its neat form to the surface of the optical fiber. Alternatively, the adhesion promoter (in any state (e.g. gas, liquid, or solid) may be combined (mixed, dissolved, diluted etc.) with a solvent to form a solution and the solution can be applied to the surface of the optical fiber. The solution may be non-curable, or non-radiation curable. The adhesion promoter interacts with the surface of the optical fiber to form an adhesion-primer layer. The adhesion promoter includes one or more functional groups. At least one of the functional groups reacts with the surface of the optical fiber to form a chemical bond to attach the adhesion promoter to the surface of the optical fiber. A primary coating composition is applied to the adhesion-primer layer and cured to form a primary coating. The adhesion promoter may include a functional group that reacts with the primary coating or with one or more components of the primary coating composition. A secondary coating composition may be applied over the primary coating composition or the primary coating and cured to form a secondary coating.

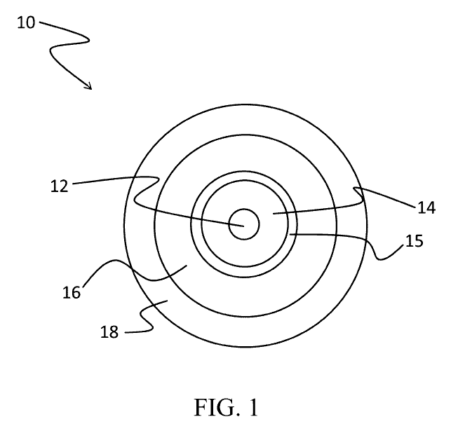

An example of a coated optical fiber is shown in schematic cross-sectional view in FIG. 1. Coated optical fiber 10 includes a glass optical fiber having a core 12 and a cladding 14 surrounded by primary coating 16 and secondary coating 18. Adhesion primer layer 15 is at the interface between cladding 14 and primary coating 16 and includes an adhesion promoter that improves adhesion of primary coating 16 to the optical fiber.

Lack of adhesion is a common problem that arises in the coating of glass optical fibers. In order to realize the beneficial effects of the coating, the coating must adhere well to the optical fiber and remain durable over time. The coating, for example, must not delaminate or peel from the optical fiber. Adhesion promoters are compounds that improve adhesion of coatings to optical fibers by physically or chemically linking the coating to the surface of the optical fiber. Physical interactions include intermolecular forces (e.g. ionic or electrostatic forces) and steric effects (e.g. molecular entanglements). Chemical interactions include formation of chemical bonds (e.g. covalent bonds).

In one embodiment, the adhesion promoter links the primary coating to the surface of the optical fiber through a physical interaction with the surface of the optical fiber and a physical interaction with the primary coating or a component of the primary coating composition. In another embodiment, the adhesion promoter links the primary coating to the surface of the optical fiber through a physical interaction with the surface of the optical fiber and a chemical interaction with the primary coating or a component of the primary coating composition. In still another embodiment, the adhesion promoter links the primary coating to the surface of the optical fiber through a chemical interaction with the surface of the optical fiber and a physical interaction with the primary coating or a component of the primary coating composition. In yet another embodiment, the adhesion promoter links the primary coating to the surface of the optical fiber through a chemical interaction with the surface of the optical fiber and a chemical interaction with the primary coating or a component of the primary coating composition.

In one embodiment, the adhesion promoter is multifunctional and includes one functional group intended to chemically interact with the substrate and a second functional group intended to chemical interact with the primary coating or a component of the primary coating composition. The surface of the optical fiber may include reactive groups or sites and the adhesion promoter may be designed to incorporate a functional group that reacts with such reactive groups or sites. Similarly, the primary coating or a component of the primary coating composition may include a reactive functional group and the adhesion promoter may be designed to include a functional group that reacts with the reactive functional group of the coating.

The surface of a glass optical fiber typically includes reactive hydroxyl groups. Adhesion promoters with acid or hydroxyl groups can react with surface hydroxyl groups through condensation reactions to form a bond that links the adhesion promoter to the optical fiber. The adhesion promoter may further include a second functional group for reaction with the primary coating (or a component of the primary coating composition) to complete the link that chemically attaches the coating (or a component of the primary coating composition) to the optical fiber.

In some embodiments, two or more adhesion promoters are combined to adhere the primary coating (or component of a primary coating composition) to the surface of an optical fiber, where at least one compound physically or chemically interacts with the surface of the optical fiber and at least one compound physically or chemically interacts with the coating or a component of the coating composition. In other embodiments, the adhesion promoter includes a first compound that physically or chemically interacts with the surface of the optical fiber and a second compound that physically or chemically interacts with the primary coating (or a component of the primary coating composition), where the first and second compounds further physically or chemically interact with each other to form a continuous link between the primary coating (or a component of the primary coating composition) and the surface of the optical fiber. In still other embodiments, the adhesion promoter includes a first compound with a functional group that reacts with the surface of the optical fiber and a second compound with a functional group that reacts with the primary coating composition (or a component of the primary coating composition), where the first and second compounds further react with each other to form a continuous chemical link between the primary coating (or a component of the primary composition) and the surface of the optical fiber.

Representative functional groups of adhesion promoters designed to react with a primary coating (or component of a primary coating composition) include amine groups, acid groups, isocyanate groups, hydroxyl groups, and ethylenically unsaturated groups. Important classes of commercially available adhesion promoters include organofunctional silanes, mercaptans, organofunctional acids, organofunctional phosphates, and organofunctional metallates (e.g. organofunctional titanates and zirconates).

In one embodiment, the adhesion promoter is an organofunctional silane compound having the general formula RₙSiX₄₋ₙ, where R is a non-hydrolyzable organic group that possesses a functionality which enables the adhesion promoter to physically or chemically interact with organic resins and polymers, X is a hydrolyzable group, such as alkoxy, acyloxy, amine or a halogen such as chlorine, and n is an integer ranging from 0 to 4 or from 1 to 3.

Representative organofunctional silane adhesion promoters include, but are not limited to, alkyltrialkoxysilanes, methyltriethoxysilane, methyltrimethoxysilane, octyltrimethoxysilane, octadecyltrimethoxysilane, polyalkoxysiloxane compounds, aminoalkyltrialkoxysilane, γ-aminopropyltriethoxysilane, γ-aminopropyltrimethoxysilane, N-β-(aminoethyl)-γ-aminopropyltrimethoxysilane, γ-ureido propyltriethoxysilane, N-(2-aminoethyl)-3-aminopropyltrimethoxysilane, 13-(3,4-epoxycyclohexyl)ethyltrimethoxysilane, γ-glycidoxy propyltrimethoxysilane, epoxypropyltrimethoxysilane, γ-mercaptopropyltriethoxysilane, mercaptoalkyltrialkoxysilane, γ-mercaptopropyltrimethoxysilane, N-methylaminopropyl-trimethoxysilane, 3-azidopropyltriethoxysilane, 3-acryloxypropyltrimethoxylsilane, 3-methacryloxypropyltrimethoxysilane, and 1,4-bis(trimethoxysilylethyl)benzene.

Other organofunctional silanes include alkoxysilane compounds having the formula (RO)₃—Si—(CH₂)ₙ—Si(OR)₃, where R is a methyl or ethyl group, and n is an integer from 1 to 10. Alternatively, the alkoxysilane compound may have the formula (RO)₃—Si—O(R′₂SiO)ₙ—Si(OR)₃, wherein R is a methyl or ethyl group, R′ is an RO—, alkyl, or aryl group, and n is an integer from 1 to 20. The adhesion promoter may also include an additional compound to catalyze the reaction between SiOR groups in the presence of atmospheric moisture or between SiOR group and a hydroxyl group on the surface of the optical fiber.

In another embodiment, the adhesion promoters include organohalosilane compounds, such as those having the formula (R¹)ₙ—Si—Cl₄₋ₙ, where n is the integer 1, 2, or 3 and the le substituent can be a 1-18 carbon linear, branched, cyclic alkyl or alkylene group, or a enediyne, phenyl, vinyl, naphthyl, or benzyl group, or hydrogen and R¹ can be in combination with the same or different R¹ groups if n is 2 or 3. Examples include methyltrichlorosilane, methyldichlorosilane, dimethyldichlorosilane, 3-chloropropyltrimethoxysilane, and fluorinated acrylamide silane compounds.

In another embodiment, the adhesion promoter includes an organofunctional silane compound with an unsaturated group, such as allyltrimethoxysilane, allyltriethoxysilane, vinyltrialkoxysilane, vinyltrichlorosilane, methylvinyldichlorosilane, vinyltriethoxysilane, vinyltrimethoxysilane, vinyl-tris-(2-methoxyethoxysilane), vinyltriacetoxysilane, methacryloxyalkyltrialkoxysilane, γ-methacryloxypropyltrimethoxysilane, γ-methacryloxypropyltrimethoxysilane, γ-methacryloxypropyl-tris-(2-methoxyethoxy)silane, and acryloxypropyltrimethoxyl-silane, N-[2-(vinylbenzylamino)-ethyl]-3-aminopropyltrimethoxysilane.

The adhesion promoter may also include a vinyl ether urethane silane or a vinyl ether urethane titanate compound, such as compounds having the general formula R₁—R₂—R₃—R₄-A-(R₅)ₙ(R₆)₃₋ₙ wherein A is either Si or Ti, R₁ is alkenoxy or ethylenically unsaturated dicarboxylic acid, R₂ is a 2-18 carbon-containing group which is a linear, branched, or cyclic alkyl, alkenyl, alkynyl, acyl, aryl, or poly(alkoxy) group, R₃ is a urethane, urea, or thiourethane linking group, R₄ is a 2-18 carbon-containing group which is linear, branched, or cyclic alkyl, alkenyl, alkynyl, acyl, or aryl non-hydrolyzable silyl linking group, R₅ is a 1-18 carbon-containing group which is linear, branched, or cyclic alkyl, alkenyl, alkynyl, acyl, or aryl group, and R₆ is a 2-18 alkoxy or alkenoxy carbon or a halogen group, and n represents 0, 1, or 2.

Still other representative adhesion promoters include azidosilane compounds and aminoalkoxysilane compounds. The azidosilane compounds have the formula N₃—R³—Si—R¹ₖ(OR²)₃₋ₖ, where le represents a C₁-C₃-alkyl, phenyl, benzyl, or toluyl group, R² represents a C₁-C₄-alkyl or C₂-C₄-alkoxyalkyl, phenyl or benzyl group, R³ represents a C₁-C₈ -alkylene group, which can be interrupted by an oxygen atom, sulfur atom or a —(N—R⁴)-group, where R⁴ denotes a hydrogen, or a methyl, ethyl or phenyl group, and k represents 0, 1, or 2. The aminoalkoxysilane compounds have the formula H₂N—R⁵—Si—R⁶ₘ(OR⁷)₃₋ₘ, where R⁵ represents a group selected from the group consisting of C₁-C₆ -alkylene or a C₅-C₆-cycloalkylene or arylene group, which may additionally be substituted by one or two C₁-C₃ -alkyl groups, and R⁶ and R⁷, independently, represent a C₁-C₆ -alkyl or a C₅-C₆ -cycloalkyl group, which may additionally be substituted by one or two C₁-C₃ -alkyl groups and m represents 0, 1, or 2.

In another embodiment, the adhesion promoter includes an acidic compound, such as acrylated sulfonic acid, methacrylated sulfonic acid, acrylated sulfonic acid anhydride, methacrylated sulfonic acid anhydride, acrylated carboxylic acid, methacrylated carboxylic acid, acrylated carboxylic acid anhydride, acrylated phosphoric acid, and methacrylated phosphoric acid.

The adhesion promoter may also include a metal alkoxide compound, such as those used in sol-gel processing. Examples include Al(OC₄H₉)₃, LiOH, Ti(OC₃H₇)₄, and Zr₂(C₅H₇O₂)₄.

As noted hereinabove, organofunctional adhesion promoters include alkoxy compounds. Preferred alkoxy compounds include alkoxysilanes. An alkoxysilane includes one or more alkoxy groups (—OR groups, where R is an organic group) bonded to a silicon atom. An alkoxysilane may also include one or more organic groups (—R) bonded to the silicon atom. The one or more organic groups (—R) may be non-hydrolyzable. A representative general formula of an alkoxysilane may be expressed (R₁)ₙSi(OR₂)₄₋ₙ, where R₁ and R₂ are non-hydrolyzable organic groups that may be the same or different and 0≦n≦4. When two or more alkoxy groups are present, the organic group of the different alkoxy groups may be the same or different. The alkoxy group(s) may physically or chemically interact with the surface of the optical fiber and the organic group(s) may physically or chemically interact with the primary coating (or a component of the primary coating composition). Alkoxy groups, upon hydrolysis with water, form silanol groups (Si—OH), which can react with hydroxyl groups on the surface of the optical fiber to form a chemical bond between the adhesion promoter and surface of the optical fiber.

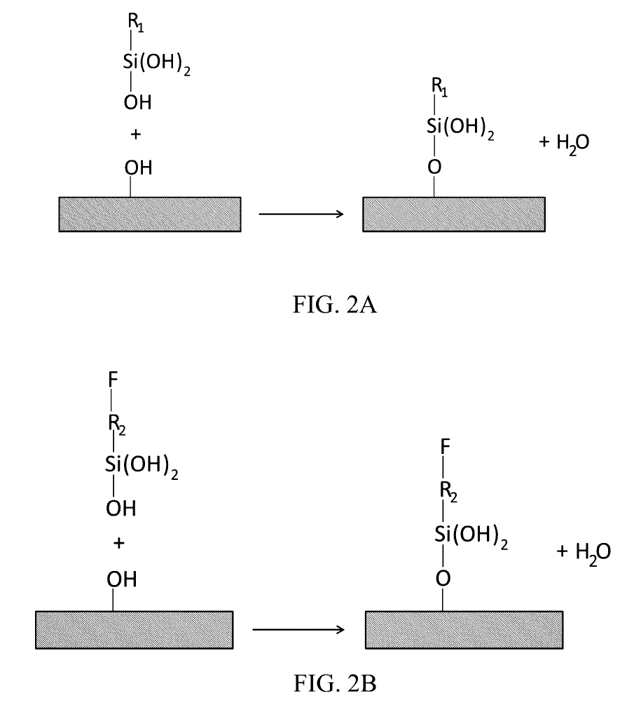

FIGS. 2A and 2B depict reaction of hydrolyzed alkoxysilane adhesion promoters with a hydroxyl group on the surface of an optical fiber. In FIG. 2A, the hydrolyzed alkoxysilane compound has the formula R₁Si(OH)₃, where R₁ is an organic group. Reaction of a silanol group with the surface hydroxyl group of the optical fiber forms a chemical bond (with an —O—Si—O-link) between the adhesion promoter and the surface of the optical fiber. Water is released as a byproduct of the reaction. The organic group R₁ lacks a reactive functional group and may interact physically with the primary coating (or component of the primary coating composition) to improve adhesion. FIG. 2B depicts a similar reaction of the hydrolyzed alkoxysilane compound having the formula F—R₂—Si(OH)₃ with a surface hydroxyl group of an optical fiber. The group F is a reactive functional group capable of chemically interacting with the primary coating (or a component of the primary coating composition) to improve adhesion.

Organic groups of any of the adhesion promoters disclosed herein may be designed as described in FIGS. 2A and 2B to physically or chemically interact with the primary coating or a component of the primary coating composition. The present adhesion promoters may include a combination of organic groups, some of which physically interact with the primary coating or a component of the primary coating composition and some of which chemically interact with the primary coating or a component of the primary coating composition. Alternatively, all of the organic groups may interact physically or all or the organic groups may interact chemically with the primary coating or a component of the primary coating composition.

The adhesion promoter may be applied directly to the surface of the optical fiber as a neat liquid or as a component of a liquid solution. The liquid solution may include a solvent and the adhesion promoter may be dissolved, suspended, dispersed, or otherwise distributed in the solvent. The solvent acts as a diluent and may be used to control the concentration of the adhesion promoter and/or the viscosity of the liquid solution. In one embodiment, the solvent is a volatile organic liquid. Exemplary solvents include alcohols, ethanol, ketones, esters, ethers, and aromatics like toluene, xylene, mesitylene.

In a preferred embodiment, the optical fiber is in continuous motion as the adhesion promoter is applied to its surface. In a continuous optical fiber manufacturing process, an optical fiber is drawn from a heated preform positioned in a draw furnace and passed through a series of processing stages. The draw speed of the optical fiber may be at least 10 m/s, or at least 20 m/s, or at least 30 m/s, or at least 40 m/s, or at least 50 m/s, or in the range from 10 m/s-90 m/s, or in the range from 20 m/s-80 m/s, or in the range from 30 m/s-65 m/s. Processing stages typically include metrology units (e.g. fiber diameter control) to assess quality and other characteristics of the optical fiber, heating stages, a primary coating stage, a secondary coating stage, an ink layer stage, and a spool or other winding stage to receive and store the coated optical fiber. The pathway traversed by the optical fiber as it passes from the draw furnace to the winding stage may be referred to herein as the process pathway of the optical fiber. The process pathway may be linear or may include turns. The upstream direction of the process pathway is the direction toward the preform and the downstream direction of the process pathway is the direction toward the winding stage. Positions or processing units upstream from a reference position or processing unit are closer, along the process pathway, to the preform than the reference position or processing unit.

Uniformity in the application of liquids (including liquid adhesion promoters, liquid solutions of adhesion promoters, liquid primary and secondary coating compositions, and liquid ink layer compositions) to the surface of the optical fiber is needed to achieve consistent and reproducible manufacturing. Uniformity includes uniformity in thickness, coverage, and composition of a liquid on the surface of the optical fiber. In order to achieve uniform application of liquids to the surface of the optical fiber, the viscosity of the liquid needs to be controlled. A liquid that is too viscous is difficult to apply uniformly and often results in variability in coating or layer thickness beyond acceptable manufacturing tolerances. A liquid that is insufficiently viscous, however, can drain off the fiber and leave bare regions on the surface of the optical fiber. Depending on the physical state (liquid vs. non-liquid) and viscosity of the adhesion promoter (if liquid), the adhesion promoter can be combined with a solvent to provide a liquid solution having a viscosity suitable for continuous fiber manufacturing.

The processing stage for applying the adhesion promoter is positioned upstream of the processing stage used to apply the primary coating. Positioning the processing stage for applying the adhesion promoter upstream from the processing stage for applying the primary coating insures that the optical fiber drawn from the preform receives the adhesion promoter before the primary coating is applied.

After the adhesion promoter or liquid solution containing the adhesion promoter has been applied to the surface of the optical fiber, it forms an adhesion primer layer. Formation of the adhesion primer layer may include reaction of the adhesion promoter with itself or a functional group on the surface of the optical fiber. Formation of the adhesion primer layer may also include physical interaction of the adhesion primer with the surface of the optical fiber or itself. Physical interactions of the adhesion primer with itself may include structural rearrangement or alignment of the molecules of the adhesion promoter.

When applied as a liquid solution, formation of the adhesion primer layer may also include evaporation of solvents. The evaporation may be assisted with a flowing gas and/or heating. The temperature of the surface of the optical fiber varies with position along the process pathway and an adhesion promoter (neat or in liquid solution form) can be applied at a point in the process pathway at which the surface of the optical fiber is at a temperature above room temperature to facilitate formation of the adhesion primer layer. At the time of application of the adhesion promoter (as a neat liquid or in the form of a liquid solution), the surface temperature of the optical fiber may be at least 30° C., or at least 40° C., or at least 50° C., or at least 60 ° C., or in the range from 30° C.—normal boiling temperature of the solvent used for a liquid solution of the adhesion promoter, or in the range from 30° C.—normal boiling temperature of the adhesion promoter, or in the range from 30° C.-110° C., or in the range from 40° C.-100° C., or in the range from 50° C.-90° C.

The thickness of the adhesion primer lay needs to be controlled. If the thickness of the adhesion primer layer is too large, the adhesion primer layer may become brittle and the strength of adhesion of the adhesion primer layer with the primary coating may be compromised. The thickness of the adhesion primer layer depends on the thickness of liquid adhesion primer (neat or in liquid solution). The thickness of liquid adhesion primer applied to the surface of the optical fiber may be at least 10 nm, or at least 25 nm, or at least 50 nm, or at least 100 nm, or at least 250 nm, or at least 500 nm, or at least 1 μm, or at least 2 μm, or at least 5 μm, or at least 10 μm, or in the range from 10 nm-20 μm, or in the range from 100 nm-15 μm, or in the range from 250 nm-10 μm, or in the range from 500 nm-5 μm. Suitable thicknesses for neat adhesion primers are expected to be smaller than suitable thicknesses for adhesion primers in liquid solution. When applied as a liquid solution, solvent is evaporated to reduce thickness to for an adhesion primer layer. The thickness of the adhesion primer layer may be at least 5 nm, or at least 10 nm, or at least 25 nm, or at least 50 nm, or at least 75 nm, or at least 100 nm, or at least 150 nm, or at least 200 nm, or in the range from 1 nm-300 nm, or in the range from 10 nm-250 nm, or in the range from 25 nm-225 nm, or in the range from 50 nm-200 nm.

The adhesion promoter may be applied to the surface of the optical fiber by covering the surface of the optical fiber with the adhesion promoter. The surface of the optical fiber can be covered with the adhesion promoter by distributing the adhesion promoter in liquid form on the surface of the optical fiber. Liquid forms of the adhesion promoter include the neat state (if the adhesion promoter is a liquid at operating conditions) and the liquid solution state. The liquid form of the adhesion promoter may be in motion (e.g. sprayed or flowed) or stationary (e.g. in a reservoir). In one embodiment, the liquid form of the adhesion promoter is in motion in a state of laminar flow.

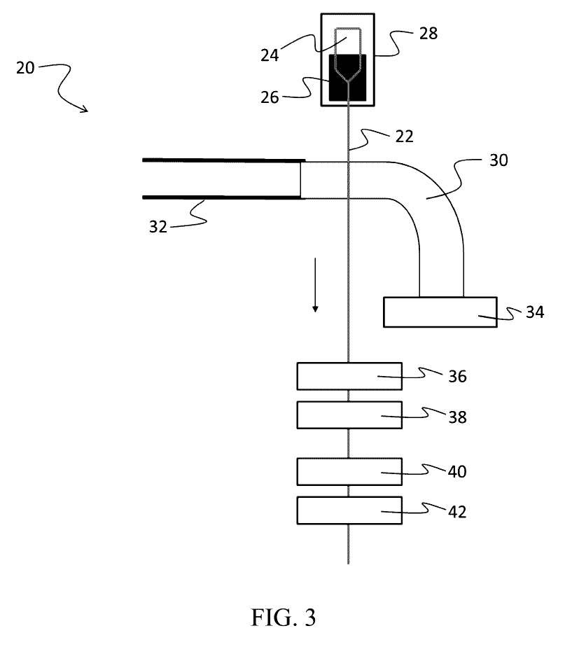

FIG. 3 depicts an embodiment in which an adhesion promoter in liquid form is applied as a moving stream to a glass optical fiber. System 20 includes glass optical fiber 22, which is drawn from preform 24 positioned in heated region 26 of draw furnace 28. The optical fiber exits draw furnace 28 along a process pathway in the direction depicted by the arrow and passes through liquid stream 30 that contains an adhesion promoter. Liquid stream 30 is supplied by nozzle 32, passes across optical fiber 22, and is collected in pan 34. System 20 may include a pump for recycling or recirculating liquid stream 30 from pan 34. After application of the adhesion promoter, the adhesion primer layer forms and the optical fiber passes through primary coating application stage 36, primary coating curing stage 38, secondary coating application stage 40, and secondary coating curing stage 42. Primary coating application stage 36 applies a curable primary coating composition to the adhesion primer layer. The curable primary coating composition is cured at primary coating curing stage 38 to form a primary coating. Secondary coating application stage 40 applies a curable secondary coating composition to the primary coating. The curable secondary coating composition is cured at secondary coating curing stage 42 to form a secondary coating. After formation of the secondary coating, an ink layer may be applied to the secondary coating (not shown) and the optical fiber may be wound on a spool (not shown).

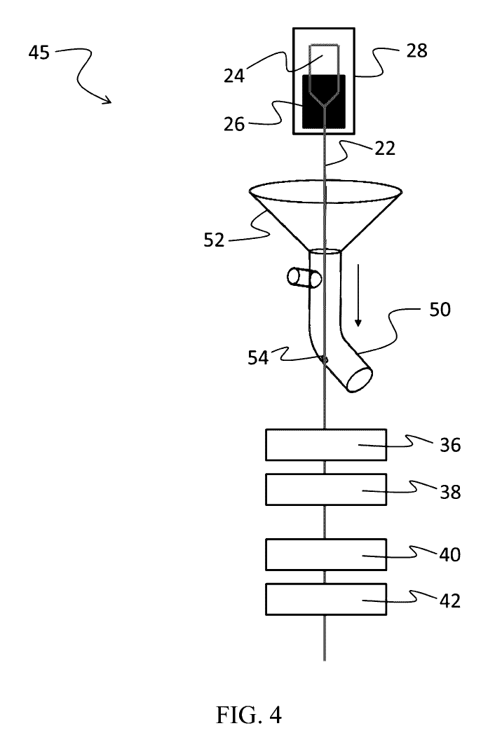

FIG. 4 depicts an embodiment in which an adhesion promoter in liquid form is applied as a moving stream to a glass optical fiber. System 45 includes glass optical fiber 22, which is drawn from preform 24 positioned in heated region 26 of draw furnace 28. The optical fiber exits draw furnace 28 along a process pathway in the direction depicted by the arrow and passes through curved tube 50 that is filled with an adhesion promoter in liquid form. Curved tube 50 is equipped with funnel 52 in which the liquid adhesion promoter can be supplied or stored. The depth of adhesion promoter liquid in funnel 52 and length of curved tube 50 permit control of the depth of the liquid form of the adhesion promoter through which optical fiber 22 passes. Depth control permits optimization of delivery of the liquid adhesion promoter to the surface of optical fiber 22. Curved tube 50 includes a hole 54 in the wall of the tube. Optical fiber 22 exits curved tube 50 at hole 54 and proceeds to primary coating application stage 36, primary coating curing stage 38, secondary coating application stage 40, and secondary coating curing stage 42. If the flow of the adhesion promoter liquid is laminar and hole 54 is sufficiently small, the adhesion promoter liquid will not leak through hole 54. After formation of the secondary coating, an ink layer may be applied to the secondary coating (not shown) and the optical fiber may be wound on a spool (not shown).

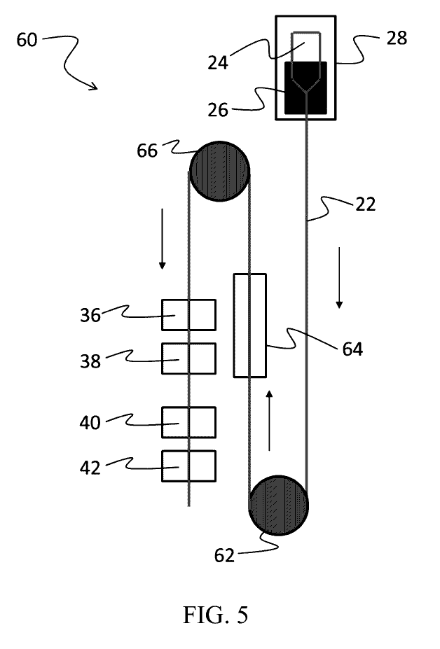

FIG. 5 depicts an embodiment in which an adhesion promoter in liquid form is applied from a stationary reservoir to a glass optical fiber. System 60 includes glass optical fiber 22, which is drawn from preform 24 positioned in heated region 26 of draw furnace 28. Optical fiber 22 exits draw furnace 28 along a process pathway in the direction depicted by the arrows.

The process pathway includes fiber-turning devices 62 and 66 that redirect the optical fiber from one direction of conveyance to another direction of conveyance. Exemplary fiber-turning devices include those described in U.S. Pat. No. 7,937,971. Optical fiber 22 exits fiber-turning device 62, passes through adhesion promoter application stage 64, and is redirected by fiber-turning device 66 to primary coating application stage 36, primary coating curing stage 38, secondary coating application stage 40, and secondary coating curing stage 42.

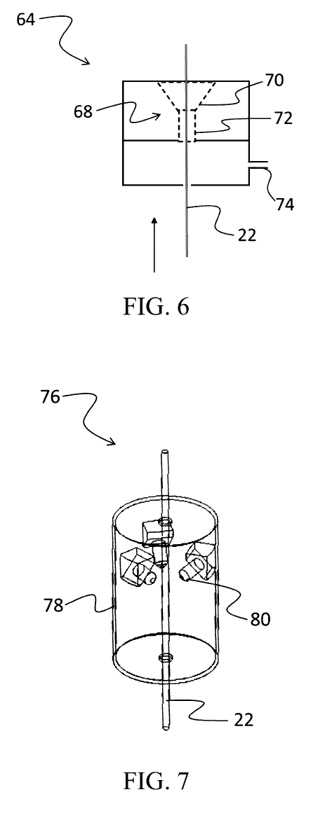

FIG. 6 shows details of adhesion promoter application stage 64. Adhesion promoter application stage 64 includes die 68 having an upper portion 70 and a lower portion 72. The adhesion promoter in liquid form is stored in die 68. The depth of adhesion promoter in liquid form in die 68 can be controlled and the adhesion promoter in liquid form is replenished from a feedstock (not shown) during processing. The widths of upper portion 70 and lower portion 72 can be designed to prevent optical fiber 22 from contacting the sidewalls of die 68. In the configuration shown in FIG. 5, optical fiber 22 enters adhesion promoter application stage 64 from below and the adhesion promoter is applied to optical fiber 22 as it passes through die 68 and continues toward fiber-turning device 66. To prevent drainage of the liquid adhesion promoter from die 68, a pressurized gas (e.g. CO₂) can be supplied from below through inlet 74.

FIG. 7 shows an embodiment of a device that can be used to provide or maintain uniformity of the liquid adhesion promoter on optical fiber 22. Device 76 includes housing 78 and is equipped with gas nozzles 80 for supplying a gas to the liquid adhesion promoter on the surface of optical fiber 22. Optical fiber 22 enters housing 78 after having received an adhesion promoter in liquid form on its surface. The adhesion promoter in liquid form is applied in any fashion in accordance with the present description, including by the illustrative embodiments depicted in FIGS. 4, 5 and 6. As optical fiber 22 passes through housing 78, it is subjected to a stream of gas pressure supplied by nozzles 80. The gas blows away excess amounts of liquid adhesion promoter to leave a uniform thin film of suitable thickness of liquid adhesion promoter on the surface of optical fiber 22.

In embodiments in which the adhesion promoter is applied as a liquid solution, the gas may facilitate evaporation of the solvent. Evaporation of the solvent may also be facilitated by heating. A heater may be integrated with housing 78 or heated gas may be supplied by nozzles 80. A separate heating stage (not shown) may be included along the fiber process pathway to aid evaporation of the solvent. A tubular heater, for example, may be included in the process pathway and the optical fiber may pass through the tubular heater to remove solvent. The length and temperature of the tubular may be configured to achieve the degree of solvent evaporation desired for a particular solvent.

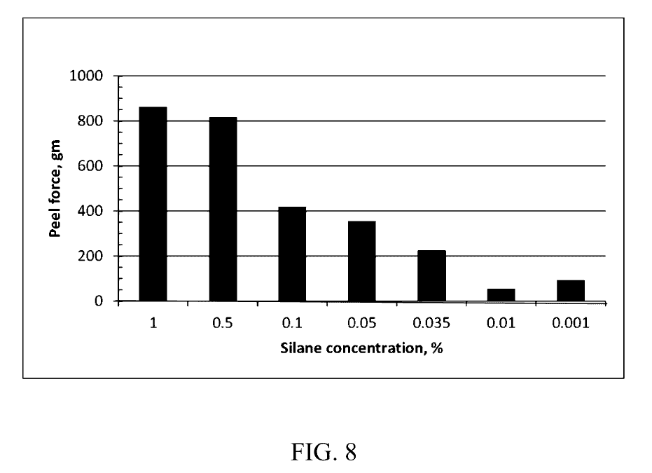

FIG. 8 shows the strength of adhesion of a silane-based adhesion primer layer to the surface of a silica glass slide. Strength of adhesion is measured as peel force, which is the force required to peel the layer from the glass slide. A higher peel force corresponds to stronger adhesion of the adhesion primer layer to the glass surface. A solution of the silane adhesion promoter in a solvent was prepared. The concentration of the adhesion promoter in the solvent was varied between 0.0001 wt % to 1 wt % to obtain a series of samples to assess the dependence of peel force on the concentration of adhesion promoter in the liquid solution. A film of thickness 12.5 μm of each of the liquid solutions was applied to the surface of separate glass slides. The solutions were allowed to stand for sufficient time to permit solvent to evaporate to form an adhesion primer layer. The peel force of each adhesion primer layer was measured. The force was applied at an angle of 90° (the direction parallel to the surface of the glass slide). The results indicate that the peel force increased with increasing concentration of adhesion promoter in the solution and that the increases slows and levels off above 0.5 wt %. The maximum peel force occurs at an adhesion promoter concentration of 1 wt %. Adequate adhesion of the adhesion promoter to the glass occurs for adhesion promoter concentrations in the range from 0.4 wt %-1.75 wt %, or in the range from 0.5 wt %-1.5 wt %, or in the range from 0.7 wt %-1.25 wt %.

The amount of adhesion promoter in liquid solution applied to the surface of the optical fiber can be expressed in terms of the product of the concentration of the adhesion promoter in the liquid solution and the initial thickness of liquid solution applied to the surface of the optical fiber. The initial thickness of the liquid solution refers to the thickness at the time of application of the liquid solution to the surface of the optical fiber, before any appreciable solvent evaporation has occurred. By way of example, if a liquid solution having 1 wt % of adhesion promoter is initially applied at a thickness of 12.5 μm, the amount of adhesion promoter applied to the surface of the optical fiber may be expressed as 12.5 wt %-μm. Similarly, if a liquid solution having 0.5 wt % of adhesion promoter is initially applied at a thickness of 12.5 μm, the amount of adhesion promoter applied to the surface of the optical fiber may be expressed as 6.25 wt %-μm. This measure of the amount of adhesion promoter embodies the notion that the amount of adhesion promoter correlates with either the concentration of adhesion promoter in the solution or the initial thickness of the liquid solution containing the adhesion promoter to the surface of the optical fiber.

The amount of adhesion promoter applied to the surface of the optical fiber in the form of an adhesion promoter in liquid solution with a solvent may be in the range from 0.04 wt %-μm-20 wt %-μm, or in the range from 0.10 wt %-μm-18 wt %-μm, or in the range from 0.25 wt %-μm-16 wt %-μm, or, in the range from 0.50 wt %-μm-14 wt %-μm, or in the range from 0.75 wt %-μm-2 wt %-μm, or in the range from 1.0 wt %-μm-10 wt %-μm, or in the range from 1.5 wt %-μm-8 wt %-μm.

When the adhesion promoter is a liquid and applied neat to the optical fiber, the concentration is 100 wt % and the amount of adhesion promoter on the surface of the optical fiber is proportional to the initial thickness of adhesion promoter applied to the surface of the optical fiber. The initial thickness of adhesion promoter in a neat liquid state applied to the surface of the optical fiber may be in the range from 0.20 nm-200 nm, or in the range from 0.40 nm-170 nm, or in the range from 0.50 nm-130 nm, or in the range from 1.0 nm-120 nm, or in the range from 3.0 nm-100 nm, or in the range from 5.0 nm-85 nm, or in the range from 8.0 nm-70 nm, or in the range from 10.0 nm-65 nm, or in the range from 15 nm-60 nm, or in the range from 20 nm-55 nm.

The primary coating applied to the adhesion primer layer is formed from a primary coating composition. Preferably, the primary coating composition is a curable liquid composition. The primary coating is a low modulus coating that protects the core and cladding of the optical fiber from damage due to mechanical stresses. The primary coating typically has a Young's modulus greater than 0 MPa and less than 1 MPa, or less than 0.75 MPa, or less than 0.50 MPa, or less than 0.35 MPa.

The primary coating may be the cured product of a primary coating composition that includes a curable crosslinker, a curable diluent, and a polymerization initiator. A non-radiation-curable reinforcing agent may also be present. The primary coating composition may include one or more curable crosslinkers, one or more curable diluents, and/or one or more polymerization initiators. In one embodiment, the curable crosslinker is essentially free of urethane and urea functional groups.

By applying the adhesion promoter directly to the surface of the optical fiber, the primary coating composition need not include an adhesion promoter and adhesion is promoted by the presence of the adhesion promoter and/or adhesion primer layer on the surface of the optical fiber. Accordingly, in one embodiment, the primary coating composition lacks an adhesion promoter. A primary coating formed from a primary coating composition lacking an adhesion promoter also lacks an adhesion promoter.

In one embodiment, the curable crosslinker is a radiation-curable component of the primary coating composition, and as such it includes two or more functional groups capable of participating in the covalent bonding or crosslinking of the crosslinker into the polymeric coating. Exemplary functional groups capable of participating in the crosslinking include α,β-unsaturated ester, amide, imide or vinyl ether groups.

In certain embodiments, the curable crosslinker component includes one or more polyols that contain two or more α,β-unsaturated ester, amide, imide, or vinyl ether groups, or combinations thereof. Exemplary classes of such polyol crosslinkers include, without limitation, polyol acrylates, polyol methacrylates, polyol maleates, polyol fumarates, polyol acrylamides, polyol maleimides or polyol vinyl ethers comprising more than one acrylate, methacrylate, maleate, fumarate, acrylamide, maleimide or vinyl ether group. The polyol moiety of the curable crosslinker can be a polyether polyol, a polyester polyol, a polycarbonate polyol, or a hydrocarbon polyol.

The curable crosslinker component preferably has a molecular weight of between about 150 g/mol and about 15000 g/mol, in some embodiments more preferably between about 200 g/mol and about 9000 g/mol, in some embodiments preferably between about 1000 g/mol and about 5000 g/mol, in other embodiments preferably between about 200 g/mol and about 1000 g/mol. The curable crosslinker may further have a molecular weight in the range from 100 g/mol to 3000 g/mol, or in the range from 150 g/mol to 2500 g/mol, or in the range from 200 g/mol to 2000 g/mol, or in the range from 500 g/mol to 1500 g/mol.

The curable crosslinker component is present in the primary coating composition in an amount of about 1 wt % to about 20 wt %, or in an amount of about 2 wt % to about 15 wt %, or in an amount of about 3 wt % to about 10 wt %.

The curable diluent is a generally lower molecular weight (e.g., about 120 to 600 g/mol) liquid monomer that is added to the formulation to control the viscosity to provide the fluidity needed to apply the primary coating composition with conventional liquid coating equipment. The curable diluent contains at least one functional group that allows the diluent, upon activation during curing, to link to the polymer formed during the curing process from the curable crosslinker and other curable components. Functional groups that may be present in the curable diluent include, without limitation, acrylate, methacrylate, maleate, fumarate, maleimide, vinyl ether, and acrylamide groups.

Monofunctional diluents will contain only a single reactive (curable) functional group, whereas polyfunctional diluents will contain two or more reactive (curable) functional groups. Whereas the former can link to the polymer network during curing, the latter can form crosslinks within the polymer network.

Suitable polyfunctional ethylenically unsaturated monomer diluents include, without limitation, methylolpropane polyacrylates with and without alkoxylation such as ethoxylated trimethylolpropane triacrylate with the degree of ethoxylation being 3 or greater, preferably ranging from 3 to about 30 (e.g. Photomer 4149 available from IGM Resins, and SR499 available from Sartomer Company, Inc.), propoxylated trimethylolpropane triacrylate with the degree of propoxylation being 3 or greater, preferably ranging from 3 to 30 (e.g. Photomer 4072 available from IGM Resins; and SR492 and SR501 available from Sartomer Company, Inc.), and ditrimethylolpropane tetraacrylate (e.g. Photomer 4355 available from IGM Resins); alkoxylated glyceryl triacrylates such as propoxylated glyceryl triacrylate with the degree of propoxylation being 3 or greater (e.g. Photomer 4096 available from IGM Resins; and SR9020 available from Sartomer Company, Inc.); erythritol polyacrylates with and without alkoxylation, such as pentaerythritol tetraacrylate (e.g. SR295 available from Sartomer Company, Inc.), ethoxylated pentaerythritol tetraacrylate (e.g. SR494 available from Sartomer Company, Inc.), and dipentaerythritol pentaacrylate (e.g. Photomer 4399 available from IGM Resins; and SR399 available from Sartomer Company, Inc.); isocyanurate polyacrylates formed by reacting an appropriate functional isocyanurate with an acrylic acid or acryloyl chloride, such as tris-(2-hydroxyethyl)isocyanurate triacrylate (e.g. SR368 available from Sartomer Company, Inc.) and tris-(2-hydroxyethyl)isocyanurate diacrylate; alcohol polyacrylates with and without alkoxylation such as tricyclodecane dimethanol diacrylate (e.g. CD406 available from Sartomer Company, Inc.), alkoxylated hexanediol diacrylate (e.g. CD564 available from Sartomer Company, Inc.), tripropylene glycol diacrylate (e.g. SR306 available from Sartomer Company, Inc.) and ethoxylated polyethylene glycol diacrylate with a degree of ethoxylation being 2 or greater, preferably ranging from about 2 to 30; epoxy acrylates formed by adding acrylate to bisphenol A diglycidylether and the like (e.g. Photomer 3016 available from IGM Resins); and single and multi-ring cyclic aromatic or non-aromatic polyacrylates such as dicyclopentadiene diacrylate.

A multifunctional radiation-curable monomer may be present in the primary coating composition at a concentration from 0.05-15 wt %, or from 0.1-10 wt %, or from 0.5-10 wt %, or from 1-5 wt %, or from 1-10 wt %, or from 1-20 wt %, or from 1-50 wt %, or from 2-8 wt %, or from 5-40 wt %, or from 10-30 wt %, or from 20-30 wt %.

It may also be desirable to use certain amounts of monofunctional ethylenically unsaturated monomer diluents, which may be introduced to influence the degree to which the cured product absorbs water, adheres to other coating materials, or behaves under stress. Exemplary monofunctional ethylenically unsaturated monomer diluents include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate (e.g. SR440 available from Sartomer Company, Inc. and Ageflex FA8 available from CPS Chemical Co.), 2-ethylhexyl acrylate, nonyl acrylate, decyl acrylate, isodecyl acrylate (e.g. SR395 available from Sartomer Company, Inc.; and Ageflex FA10 available from CPS Chemical Co.), undecyl acrylate, dodecyl acrylate, tridecyl acrylate (e.g. SR489 available from Sartomer Company, Inc.), lauryl acrylate (e.g. SR335 available from Sartomer Company, Inc., Ageflex FA12 available from CPS Chemical Co. (Old Bridge, N.J.), and Photomer 4812 available from IGM Resins), octadecyl acrylate, and stearyl acrylate (e.g. SR257 available from Sartomer Company, Inc.); aminoalkyl acrylates such as dimethylaminoethyl acrylate, diethylaminoethyl acrylate, and 7-amino-3,7-dimethyloctyl acrylate; alkoxyalkyl acrylates such as butoxylethyl acrylate, phenoxyethyl acrylate (e.g. SR339 available from Sartomer Company, Inc., Ageflex PEA available from CPS Chemical Co., and Photomer 4035 available from IGM Resins), phenoxyglycidyl acrylate (e.g. CN131 available from Sartomer Company, Inc.), lauryloxyglycidyl acrylate (e.g. CN130 available from Sartomer Company, Inc.), and ethoxyethoxyethyl acrylate (e.g. SR256 available from Sartomer Company, Inc.); single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bornyl acrylate, isobornyl acrylate (e.g. SR423 and SR506 available from Sartomer Company, Inc., and Ageflex IBOA available from CPS Chemical Co.), tetrahydrofurfuryl acrylate (e.g. SR285 available from Sartomer Company, Inc.), caprolactone acrylate (e.g. SR495 available from Sartomer Company, Inc.; and Tone M100 available from Union Carbide Company, Danbury, Conn.), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated(4) nonylphenol acrylate (e.g. Photomer 4003 available from IGM Resins; and SR504 available from Sartomer Company, Inc.) and propoxylatednonylphenol acrylate (e.g. Photomer 4960 available from IGM Resins); acrylamides such as diacetone acrylamide, isobutoxymethyl acrylamide, N,N′-dimethyl-aminopropyl acrylamide, N,N-dimethyl acrylamide, N,N-diethyl acrylamide, and t-octyl acrylamide; vinylic compounds such as N-vinylpyrrolidone and N-vinylcaprolactam (both available from Ashland Inc., Covington, Ky.); and acid esters such as maleic acid ester and fumaric acid ester.

The curable monomer diluent can include a single diluent component, or combinations of two or more monomer diluent components. The curable monomer diluent(s) is(are collectively) typically present in the primary coating composition in amounts of about 10 wt % to about 60 wt %, more preferably between about 20 wt % to about 50 wt %, and most preferably between about 25 wt % to about 45 wt %.

The radiation-curable component of the primary coating composition may include an N-vinyl amide such as an N-vinyl lactam, or N-vinyl pyrrolidinone, or N-vinyl caprolactam. The N-vinyl amide monomer may be present in the radiation-curable composition at a concentration from 0.1 wt %-40 wt %, or from 2 wt %-10 wt %.

The primary coating composition may include one or more monofunctional (meth)acrylate monomers in an amount from 5 wt %-95 wt %, or from 0 wt %-75 wt %, or from 40 wt %-65 wt %. The primary coating composition may include one or more monofunctional aliphatic epoxy (meth)acrylate monomers in an amount from 5 wt %-40 wt %, or from 10 wt %-30 wt %.

A monofunctional radiation-curable monomer may be present in the primary coating composition at a concentration from 10 wt %-60 wt %, or from 10 wt %-30 wt %, or from 30 wt %-60 wt %, or from 40 wt %-80 wt %, or from 60 wt %-80 wt %. The radiation-curable coating composition may include one or more monofunctional (meth)acrylate monomers in an amount from 5 wt %-95 wt %, or from 0 wt %-75 wt %, or from 40 wt %-65 wt %. The radiation-curable coating composition may include one or more monofunctional aliphatic epoxy (meth)acrylate monomers in an amount from 5 wt %-40 wt %, or from 10 wt %-30 wt %.

The total monomer content of the primary coating composition may be in the range from 5 wt %-95 wt %, or in the range from 20 wt %-95 wt %, or in the range from 40 wt %-95 wt %, or in the range from 60 wt %-95 wt %, or in the range from 40 wt %-85 wt %, or in the range from 60 wt %-85 wt %, or in the range from 30 wt %-75 wt %, or in the range from 40 wt % and 65 wt %.

The radiation-curable component may include a radiation-curable monofunctional or multifunctional oligomer. The oligomer may be a (meth)acrylate-terminated oligomer. The oligomer may include polyether acrylates (e.g., GENOMER 3456, available from Rahn USA (Aurora, Ill.)), polyester acrylates (e.g., EBECRYL 80, 584 and 657, available from Cytec Industries Inc. (Woodland Park, N.J.)), or polyol acrylates. The oligomer may be a di(meth)acrylate, tri(meth)acrylate, tetra(meth)acrylate, or higher (meth)acrylate. Polyol (meth)acrylates may include polyalkoxy(meth)acrylates or polyol(meth)acrylates. Examples include polyethylene glycol diacrylate and polypropylene glycol diacrylate. The monofunctional or multifunctional oligomer may lack urethane groups, urea groups, isocyanate groups, and/or hydrogen-donor groups.

In certain embodiments, the radiation-curable oligomer may include one or more polyols that contain two or more α,β-unsaturated ester, amide, imide, or vinyl ether groups, or combinations thereof. Exemplary classes of these polyol-containing oligomers include, without limitation, polyol acrylates, polyol methacrylates, polyol maleates, polyol fumarates, polyol acrylamides, polyol maleimides or polyol vinyl ethers comprising more than one acrylate, methacrylate, maleate, fumarate, acrylamide, maleimide or vinyl ether group. The polyol moiety can be a polyether polyol, a polyester polyol, a polycarbonate polyol, or a hydrocarbon polyol.

The total radiation-curable oligomer content of the primary coating composition may be less than 20 wt %, or less than 15 wt %, or less than 10 wt %, or less than 5 wt %, or less than 3wt %, or between about 0.5 wt % and about 25 wt %, or between about 1 wt % and about 15 wt %, or between about 2 wt % and about 10 wt %. In one embodiment, the primary coating composition is free of radiation-curable oligomer.

The primary coating composition includes a polymerization initiator. The polymerization initiator is a reagent that is suitable to cause polymerization (i.e., curing) of the composition after its application to a glass fiber. Polymerization initiators suitable for use in the primary coating compositions include thermal initiators, chemical initiators, electron beam initiators, and photoinitiators. The primary coating composition is preferably a radiation-curable composition and photoinitiators are the preferred polymerization initiators. For most acrylate-based coating formulations, conventional photoinitiators, such as the known ketonic photoinitiators and/or phosphine oxide photoinitiators, are preferred. Photoinitiators are reactive components and undergo reaction, rearrangement, or decomposition to provide chemical species (e.g. free radicals) capable of initiating a photoreaction with a curable component of the coating composition. The photoinitiator is present in an amount sufficient to provide rapid ultraviolet curing. The coating composition may include one or more photoinitiators. The concentration of photoinitiator(s) may be between about 0.25 wt % to about 10.0 wt %, or between about 0.5 wt % and 7.5 wt %, or between about 0.75 wt % and 5.0 wt %.

Suitable photoinitiators include, without limitation, 1-hydroxycyclohexyl-phenyl ketone (e.g. Irgacure 184 available from BASF), (2,6-dimethoxybenzoyl)-2,4,4-trimethylpentyl phosphine oxide (e.g. commercial blends Irgacure 1800, 1850, and 1700 available from BASF), 2,2-dimethoxyl-2-phenyl acetophenone (e.g. Irgacure 651, available from BASF), bis(2,4,6-trimethyl benzoyl)phenyl-phosphine oxide (e.g. Irgacure 819, available from BASF), (2,4,6-trimethylbenzoyl)diphenyl phosphine oxide (e.g. Lucirin TPO available from BASF, Munich, Germany), ethoxy(2,4,6-trimethylbenzoyl)phenyl phosphine oxide (e.g. Lucirin TPO-L from BASF), and combinations thereof

In addition to the base components (curable crosslinker, curable diluent, reinforcing agent, and polymerization initiator), the primary coating composition may also include one or more additives. The one or more additives may include an antioxidant, a catalyst, a carrier or surfactant, a tackifier, a stabilizer, or an optical brightener. Some additives (e.g., catalysts, reactive surfactants, and optical brighteners) may operate to control the polymerization process and may thereby affect the physical properties (e.g., modulus, glass transition temperature) of the cured product formed from the coating composition. Other additives may influence the integrity of the cured product of the coating composition (e.g., protection against UV-induced curing or oxidative degradation).

The secondary coating is formed from a secondary coating composition. The secondary coating composition is preferably a curable liquid composition or a radiation-curable liquid composition. The radiation-curable secondary coating composition may include one or more monomers, one or more oligomers, and one or more photoinitiators. The radiation-curable secondary coating composition may also optionally include additives such as anti-oxidants, optical brighteners, catalyst(s), a carrier or surfactant, and a stabilizer. Suitable photoinitiators include those described hereinabove for the primary coating composition.

The radiation-curable secondary coating composition may lack an oligomer. Although not required, it is preferable that the monomeric component be a combination of two or more monomers when the composition is devoid of the oligomeric component.

Preferably, the monomeric component of the secondary coating composition includes ethylenically unsaturated monomer(s). While the monomeric component can be present in an amount of 50 wt % or more, it is preferably present in an amount of about 75 to about 99.2 wt %, more preferably about 80 to about 99 wt %, and most preferably about 85 to about 98 wt %.

In one embodiment, the secondary coating composition includes one or more ethylenically unsaturated monomers. Ethylenically unsaturated monomers may contain various functional groups which enable their cross-linking. The ethylenically unsaturated monomers are preferably polyfunctional (i.e., each containing two or more functional groups), although monofunctional monomers can also be introduced into the composition. Therefore, the ethylenically unsaturated monomer can be a polyfunctional monomer, a monofunctional monomer, and mixtures thereof. Suitable functional groups for ethylenically unsaturated monomers used in accordance with the present invention include, without limitation, acrylates, methacrylates, acrylamides, N-vinyl amides, styrenes, vinyl ethers, vinyl esters, acid esters, and combinations thereof (i.e., for polyfunctional monomers).

Suitable polyfunctional ethylenically unsaturated monomers for the secondary coating composition include, without limitation, alkoxylated bisphenol A diacrylates such as ethoxylated bisphenol A diacrylate with ethoxylation being 2 or greater, preferably ranging from 2 to about 30 (e.g. SR349 and SR601 available from Sartomer Company, Inc. West Chester, Pa. and Photomer 4025 and Photomer 4028, available from Cognis Corp. (Ambler, Pa.)), and propoxylated bisphenol A diacrylate with propoxylation being 2 or greater, preferably ranging from 2 to about 30; methylolpropane polyacrylates with and without alkoxylation such as ethoxylated trimethylolpropane triacrylate with ethoxylation being 3 or greater, preferably ranging from 3 to about 30 (e.g., Photomer 4149, Cognis Corp., and SR499, Sartomer Company, Inc.), propoxylated-trimethylolpropane triacrylate with propoxylation being 3 or greater, preferably ranging from 3 to 30 (e.g., Photomer 4072, Cognis Corp: and SR492, Sartomer), and ditrimethylolpropane tetraacrylate (e.g., Photomer 4355, Cognis Corp.); alkoxylated glyceryl triacrylates such as propoxylated glyceryl triacrylate with propoxylation being 3 or greater (e.g., Photomer 4096, Cognis Corp. and SR9020, Sartomer); erythritol polyacrylates with and without alkoxylation, such as pentaerythritol tetraacrylate (e.g., SR295, available from Sartomer Company, Inc. (West Chester, Pa.)), ethoxylated pentaerythritol tetraacrylate (e.g., SR494, Sartomer Company, Inc.), and dipentaerythritol pentaacrylate (e.g., Photomer 4399, Cognis Corp., and SR399, Sartomer Company, Inc.); isocyanurate polyacrylates formed by reacting an appropriate functional isocyanurate with an acrylic acid or acryloyl chloride, such as tris-(2-hydroxyethyl) isocyanurate triacrylate (e.g., SR368, Sartomer Company, Inc.) and tris-(2-hydroxyethyl) isocyanurate diacrylate; alcohol polyacrylates with and without alkoxylation such as tricyclodecane dimethanol diacrylate (e.g., CD406, Sartomer Company, Inc.) and ethoxylated polyethylene glycol diacrylate with ethoxylation being 2 or greater, preferably ranging from about 2 to 30; epoxy acrylates formed by adding acrylate to bisphenol A diglycidylether (4 up) and the like (e.g., Photomer 3016, Cognis Corp.); and single and multi-ring cyclic aromatic or non-aromatic polyacrylates such as dicyclopentadiene diacrylate and dicyclopentane diacrylate.

It may also be desirable to use certain amounts of monofunctional ethylenically unsaturated monomers, which can be introduced to influence the degree to which the cured product absorbs water, adheres to other coating materials, or behaves under stress. Exemplary monofunctional ethylenically unsaturated monomers include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate, 2-ethylhexyl acrylate, nonyl acrylate, decyl acrylate, isodecyl acrylate, undecyl acrylate, dodecyl acrylate, lauryl acrylate, octadecyl acrylate, and stearyl acrylate; aminoalkyl acrylates such as dimethylaminoethyl acrylate, diethylaminoethyl acrylate, and 7-amino-3,7-dimethyloctyl acrylate; alkoxyalkyl acrylates such as butoxyethyl acrylate, phenoxyethyl acrylate (e.g., SR339, Sartomer Company, Inc.), and ethoxyethoxyethyl acrylate; single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bomyl acrylate, isobornyl acrylate (e.g., SR423, Sartomer Company, Inc.), tetrahydrofiurfuryl acrylate (e.g., SR285, Sartomer Company, Inc.), caprolactone acrylate (e.g., SR495, Sartomer Company, Inc.), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated(4) nonylphenol acrylate (e.g., Photomer 4003, Cognis Corp.); acrylamides such as diacetone acrylamide, isobutoxymethyl acrylamide, N,N′-dimethyl-aminopropyl acrylamide, N,N-dimethyl acrylamide, N,N diethyl acrylamide, and t-octyl acrylamide; vinylic compounds such as N-vinylpyrrolidone and N-vinylcaprolactam; and acid esters such as maleic acid ester and fumaric acid ester. With respect to the long and short chain alkyl acrylates listed above, a short chain alkyl acrylate is an alkyl group with 6 or less carbons and a long chain alkyl acrylate is alkyl group with 7 or more carbons.

The optional oligomeric component of the secondary coating composition can include a single oligomer or a combination of two or more oligomers. The one or more optional oligomers may include one or more monofunctional oligomers, one or more polyfunctional oligomers, or a combination thereof. Preferable oligomer(s) includes ethylenically unsaturated oligomer(s). Optional oligomers include aliphatic and aromatic urethane (meth)acrylate oligomers, urea (meth)acrylate oligomers, polyester and polyether (meth)acrylate oligomers, acrylated acrylic oligomers, polybutadiene (meth)acrylate oligomers, polycarbonate (meth)acrylate oligomers, and melamine (meth)acrylate oligomers.

The secondary coating is preferably a high modulus coating designed to protect the optical fiber from damage caused by bending or other forces applied to the fiber during handling. The secondary coating preferably has a Young's modulus greater than 1000 MPa, or greater than 1200 MPa, or greater than 1400 MPa, or greater than 1600 MPa, or greater than 1800 MPa.

Suitable materials for use in secondary coatings, as well as considerations related to selection of these materials, are well known in the art and are described in U.S. Pat. Nos. 4,962,992; 5,104,433; 6,584,263; 6,611,647; and 6,775,451, each of which is hereby incorporated by reference in its entirety.

The primary and secondary coating compositions are coated on the adhesion primer layer using conventional processes. As noted hereinabove, a glass fiber is drawn from a heated preform positioned in the draw furnace of a draw tower. The preform is typically a cylindrical preform that is locally and symmetrically heated to a temperature, e.g., of about 2000° C. As the preform is heated, such as by feeding the preform into and through a furnace, a glass fiber is drawn from the molten material and directed along a process pathway. The adhesion promoter is applied to the surface of the optical fiber and the primary and secondary coatings are thereafter formed on the fiber by applying and curing primary and secondary coating compositions. “Wet-on-dry” and “dry-on-dry” processes for forming primary and secondary coatings are known in the art. In the “wet-on-dry” process, the primary coating composition is applied to the adhesion primer layer and polymerized (cured) to form the primary coating. The secondary coating composition is applied to the primary coating (cured) and polymerized (cured) to form the secondary coating. In the “wet-on-wet” process, the secondary coating composition is applied to to the primary coating composition before the primary coating composition is polymerized (cured). In this process, a single polymerization (curing) step may be employed to form solid coatings from the primary and secondary coating compositions. The method of curing can be thermal, chemical, or radiation induced, such as by exposing the applied (uncured) primary or secondary coating composition on the glass fiber to ultraviolet light, actinic radiation, microwave radiation, or electron beam, depending upon the nature of the coating composition(s) and polymerization initiator employed.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A method of processing an optical fiber comprising:
applying a non-curable liquid to the surface of an optical fiber, said non-curable liquid comprising an adhesion promoter.

2. The method of claim 1, wherein said applying non-curable liquid includes spraying said non-curable liquid on said surface of said optical fiber.

3. The method of claim 1, wherein said applying non-curable liquid includes passing said optical fiber through a reservoir of said non-curable liquid.

4. The method of claim 1, wherein said applying non-curable liquid includes passing said optical fiber through a tube, said tube containing said non-curable liquid.

5. The method of claim 4, wherein said non-curable liquid is flowing in said tube.

6. The method of claim 5, wherein said flow of said non-curable liquid is laminar.

7. The method of claim 4, wherein said tube includes a wall having a hole, said optical fiber passing through said hole.

8. The method of claim 1, wherein after said applying, a gas is blown on said non-curable liquid on said surface of said optical fiber.

9. The method of claim 1, wherein said non-curable liquid is a non-radiation curable liquid.

10. The method of claim 1, wherein said optical fiber is moving at a speed of at least 10 m/s.

11. The method of claim 1, wherein said non-curable liquid further comprises a solvent.

12. The method of claim 1, wherein said non-curable liquid forms an adhesion primer layer on said surface of said optical fiber.

13. The method of claim 12, wherein said forming adhesion primer layer includes forming a chemical bond between said adhesion promoter and said surface of said optical fiber.

14. The method of claim 12, further comprising forming a first coating on said adhesion primer layer.

15. The method of claim 14, wherein said forming first coating includes forming a chemical bond between said adhesion promoter and said first coating.

16. The method of claim 14, wherein said forming first coating includes applying a first radiation-curable coating composition to said adhesion primer layer.

17. The method of claim 16, wherein said first radiation-curable coating composition lacks an adhesion promoter.

18. The method of claim 16, wherein said forming first coating further includes curing said first radiation-curable coating composition.

19. The method of claim 14, further comprising forming a second coating on said first coating.

20. The method of claim 19, wherein said forming second coating includes applying a second radiation-curable coating composition to said first coating.

21. The method of claim 19, wherein said forming first coating includes applying a first radiation-curable coating composition to said adhesion primer layer and said forming second coating includes applying a second radiation-curable composition to said first coating.

22. The method of claim 21, wherein said first radiation-curable coating composition lacks an adhesion promoter.
